(19) United States
(12) Patent Application Publication
(10) Pub. No.: US 2007/0150613 A1
(43) Pub. Date: Jun. 28, 2007

(54) Method for substitute switching of spatially separated switching systems

(76) Inventors: Norbert Lobig, Darmstadt (DE); Jurgen Tegeler, Penzberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/582,592

(22) PCT Filed: Aug. 27, 2004
(86) PCT No.: PCT/EP04/51937

§ 371 Date: Jun. 9, 2006

(30) Foreign Application Priority Data
Dec. 12, 2003 (DE) 103 58 338.6

(51) Int. Cl. G06F 15/173

(52) U.S. Cl. 709/238

(57) ABSTRACT

An identical clone, with identical hardware, identical software and an identical data base, is allocated to each switching system to be protected, as a redundancy partner. Switching is carried out in a quick, secure and automatic manner by a superordinate, real-time enabled monitor which establishes communication with the switching systems which are arranged in pairs. In the event of communication loss with respect to the active communication system, real-time switching to the redundant switching system is carried out with the aid of the central controls of the two switching systems.

### CROSS REFERENCE TO RELATED APPLICATIONS

This application is the US National Stage of International Application No. PCT/EP2004/051937, filed Aug. 27, 2004 and claims the benefit thereof. The International Application claims the benefits of German application No. 10358338.6 DE filed Dec. 12, 2003, both of the applications are incorporated by reference herein in their entirety.

### FIELD OF INVENTION

The present invention relates to a method for substitutive switching of spatially separated switching systems.

### BACKGROUND OF INVENTION

Contemporary switching systems (switches) have a high degree of internal operational reliability due to redundant provision of important internal components. A very high availability of the switching functions can therefore be achieved during normal operation. However, if large-scale external events (e.g. fire, natural disasters, terrorist attacks, war, etc.) occur, the measures which were taken for increasing the operational reliability are generally of little use because original components and substitutive components of the switching system are located in the same place and it is therefore very probable that both components will be destroyed or become inoperable in such a disaster scenario.

### SUMMARY OF INVENTION

Geographically separate 1:1 redundancy has been proposed as a solution. Accordingly, provision is made for an identical clone, as a redundancy partner having identical hardware, software and database, to be assigned to each switching system which must be protected. The clone is in a booted-up state but is not active in terms of switching. Both switching systems are controlled by a superordinate real-time enabled monitor which controls the changeover procedures.

The invention addresses the problem of specifying a method for substitutive connection of switching systems, which method ensures an efficient changeover from a failed switching system to a redundancy partner in the event of an error.

In accordance with the invention, as part of 1:1 redundancy, communication is established to the dually arranged switching systems (1:1 redundancy) by a superordinate monitor which can be realized in hardware and/or software. If communication to the active switching system is lost, the monitor changes over to the redundant switching system in real time with the aid of the central controllers of the two switching systems.

An essential advantage of the invention is that, during the changeover procedure from an active switching system to a hot-standby switching system, no network management which supports the changeover procedures is required. In this respect, it is irrelevant whether or not the network includes such network management. Furthermore, the monitor is linked to the switching systems via a permanently predefined number of interfaces (e.g. 2 in each case). From the viewpoint of the monitor, said permanently predefined number of interfaces represent interfaces to the relevant central controllers of the switching systems. The monitor is therefore independent of the configuration level of the two switching systems.

Consequently, this solution can be realized with minimal implementation cost in any switching system having IP-based interfaces. The solution can be used generally and is economical because normally only the cost of the monitor is required. It is also extremely robust because it uses simple standardized IP protocols. Consequently, incorrect control due to software errors can be virtually excluded. Incorrect controls due to temporary failures in the IP core network are rectified automatically after the failure has been cleared. A double failure of the monitor likewise does not represent a problem.

### BRIEF DESCRIPTION OF THE DRAWINGS

Advantageous developments of the invention are specified in the dependent claims.

FIG. 1 shows the network configuration according to the invention in the case of a locally redundant monitor;

FIG. 2 shows the network configuration according to the invention in the case of a geographically redundant monitor.

### DETAILED DESCRIPTION OF INVENTION

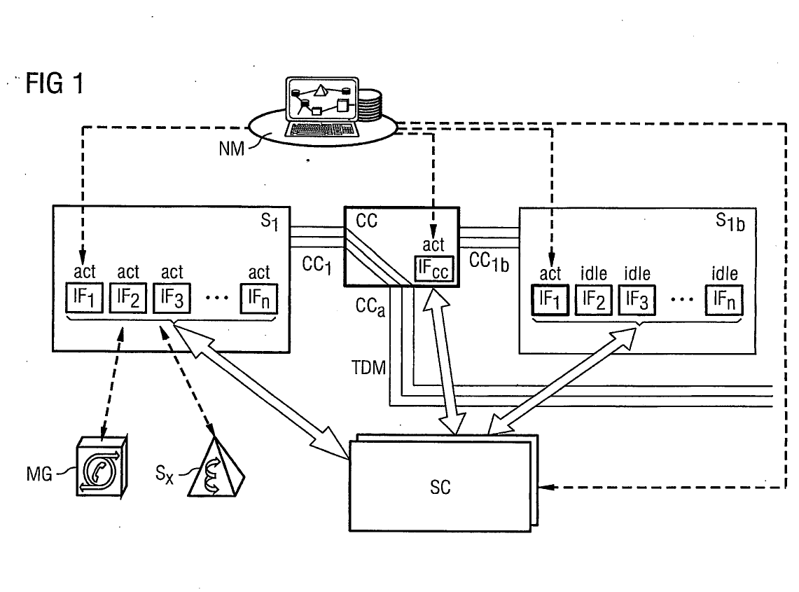

In FIG. 1, provision is made for assigning to each switching system (e.g. S₁) which must be protected an identical clone including identical hardware, software and database as a redundancy partner (e.g. S_{1b}). The clone is in the booted-up state but is not active in terms of switching (“hot standby” operating state). This defines a high-availability 1:1 redundancy of switching systems, said redundancy being distributed over a plurality of locations.

The two switching systems (switching system S₁ and the clone or redundancy partner S_{1b}) are controlled by a network management system NM. The control takes place in such a way that the current state of database and software is kept identical on both switching systems S₁, S_{1b}. This is achieved by ensuring that each operating command, each configuration command and each software update (including patches) is applied identically on both partners. In this way, a spatially remote identical clone of an operational switch is defined, including an identical database and identical software level.

The database essentially contains all semipermanent and permanent data. In this context, permanent data is understood to comprise the data which is stored as code in tables and which can only be updated by means of a patch or software update. Semipermanent data is understood to be the data which arrives in the system via the user interface, for example, and which is stored there for an extended period in the form of the input. With the exception of the configuration states of the system, this data is not generally changed by the system itself. The database does not contain the transient data which accompanies a call, said data being stored for a short period only by the system and not generally having any significance beyond the duration of a call, or state information representing transient overlays/additions to basic states which have been predetermined during configuration. (For example, a port might be active in the basic state, but momentarily inaccessible due to a transient fault).

In addition, the switching systems S₁, S_{1b} both have active packet-oriented interfaces (not shown in greater detail in FIG. 1) to the shared network management system NM. However, while all packet-oriented interfaces IF₁ . . . IFₙ are active in the case of switching system S₁, the packet-oriented interfaces are in the operating state “idle” in the case of switching system S_{1b}. The “idle” state signifies that the interfaces do not allow any message exchange in terms of switching, but can be activated from the exterior, i.e. by a superordinate real-time enabled monitor which is situated externally relative to switching system S₁ and switching system S_{1b}. The monitor can be realized in hardware and/or software, and changes over to the clone in real time in the event of an error. Real time means a time period of a few seconds here. Depending on the quality of the network, it is also possible to define a longer time period for detecting the need for the substitutive connection. According to the present exemplary embodiment, the monitor is designed as control entity SC and is duplicated for reasons of reliability (local redundancy).

The interfaces Iₙ are packet-based and therefore represent communication interfaces to packet-based peripheral entities (e.g. IAD, SIP proxy entities), remote packet-based switches (Sₓ), packet-based media gateways and servers (MG/AGW). They are indirectly controlled by the control entity SC (switch controller, SC). This means that the control entity SC can activate and deactivate the interfaces IFₙ via the central controllers CP, and therefore change back and forth between the operating states “act” and “idle” as required.

The configuration as per FIG. 1 should be considered as the default configuration. This means that the switching system S₁ is active in switching terms, while the switching system S_{1b} is in a “hot standby” operating state. This state is characterized by a current database and full activity of all components down to the packet-based interfaces (and possibly the handling of switching state-information changes). The (geographically redundant) switching system S_{1b} can therefore be converted quickly (real time) into the active switching state by the control entity SC by activating the interfaces IF_{2 . . . n}. An essential consideration here is that the two geographically redundant switching systems S₁, S_{1b} and the network management system NM and the duplicated control entity SC must be spatially clearly separate in each case.

The control entity SC transmits the current operating state of the switching systems S₁, S_{1b} (act/standby, state of the interfaces) and its own operating state to the network management NM periodically or upon request if required. For reasons of reliability, the network management NM functionality should also allow manual implementation of the changeovers described above. The automatic changeover can optionally be blocked such that the changeover can only be carried out manually.

The packet addresses (IP addresses) of the interfaces IF₁ . . . IFₙ of the switching system S₁ and those of its respective partner interfaces of switching system S_{1b} can be identical but this is not mandatory. If they are identical, the changeover is only noticed by preconnected routers. By contrast, it is completely transparent for the partner application in the network. This is also called an IP failover function in this context. If the protocol used by an interface allows a changeover of the communication partner to a different packet address, as in the case of e.g. the H.248 protocol (a media gateway can independently establish a new connection to another media gateway controller having different IP addresses), the IP addresses can also be different.

In a configuration of the invention, provision is made to use the central processor of a further switching system as control entity SC. This results in the existence of a control entity having maximal availability.

In a development of the invention, consideration is given to establishing a direct communication interface between switching system S₁ and switching system S_{1b}. This can be used for updating the database e.g. with regard to SCI (Subscriber Controlled Input) and billing data, as well as for exchanging transient data of individual connections or other important transient data (e.g. H.248 Association Handle). It is therefore possible to minimize faults in operation as perceived by subscribers and operators. The semipermanent and transient data can then be transferred from the relevant active switching system to the redundant standby switching system in a cyclical time schedule (update). Updating the SCI data has the advantage of avoiding a cyclical restore on the standby system and ensuring the currency of SCI data in the standby system at all times. By updating stack-relevant data, e.g. the H.248 Association Handle, it is possible to conceal from the peripherals that the peripherals have been transferred to a substitutive system, and the downtimes can be reduced even further.

In the following, it is assumed that a serious failure of the switching system S₁ has occurred. As a result of the geographical redundancy, it is highly probable that neither the clone (switching system S_{1b}) nor the control entity SC has been affected. The control entity SC detects the failure of switching system S₁ since its central controller CP can no longer be reached via a permanently predefined plurality of interfaces of the switching system S₁ and therefore communication loss to the central controller CP of the switching system S₁ arises.

Upon noticing the failure of switching system S₁, the control entity SC sets the geographically redundant switching system S_{1b} to an active operating state. The failed switching system goes into the “hot standby” operating state following repair/recovery. Manual intervention might be required in order to load the current database from switching system S_{1b} when switching system S₁ is booted up. The changeover can also be performed manually from the network management system NM at any time.

In the present exemplary embodiment as per the structure shown in FIG. 1, it is assumed that the switching systems S₁ and S_{1b} only have IP interfaces, and that provision is not made for terminating TDM sections at the switching system. For example, switching systems S₁ and S_{1b} are linked to the control entity SC via exactly 2 IP interfaces IF₁, IF₂ in each case. This should provide adequate redundancy, though this connection can be extended up to all n interfaces. The control entity SC itself is failure-protected as a result of its duplication.

At startup, the control entity SC (default configuration) defines the switching system S₁ as “active” in terms of switching and the switching system S_{1b} as “standby” in terms of switching, wherein the switching systems S₁ and S_{1b} are explicitly notified of this. As a result, the central controller CP of the switching system S₁ sets all n>2 interfaces IFₙ to the active switching state, whereas all n>2 interfaces IFₙ of the switching system S_{1b} are left in the “IDLE” state by its central controller CP. Switching system S_{1b} does not initially register with the edge router at all using the IP addresses which are intended for it and can be used externally for switching (for IP failover addresses and/or non-failover addresses), nor does it respond to inputs from peripherals, i.e. gateways, IADs, etc. (for non-failover addresses).

The operating state of the two switching systems S₁ and S_{1b} is monitored via the exchange of cyclical test messages between the control entity SC and the central controllers CP of the two paired switching systems S₁, S_{1b}. The exchange of cyclical test messages between the control entity SC and the central controller CP of the active switching system S₁ takes place by means of the active switching system S₁, supported by its central controller CP, cyclically registering with the control entity SC and receiving a positive acknowledgement in response to this (e.g. every 10 s). The exchange of cyclical test messages between the control entity SC and the central controller CP of the hot-standby switching system S_{1b} takes place by means of the hot-standby switching system S_{1b}, supported by its central controller CP, cyclically registering with the control entity SC and receiving no acknowledgement or a negative acknowledgement in response to this (e.g. every 10 s).

Let us assume that switching system S₁ now fails. The control entity SC (if intact) reports each verified and unacceptably long loss of communication with the central controller CP of the switching system 1 to the network management NM, wherein both interfaces IF1, IF2 are used for this purpose. Furthermore, it gives switching system S_{1b} the order to become operational by instructing the central controller CP of the switching system S_{1b} (via at least one of the interfaces IF1, IF2) to activate its switching interfaces. Since the control entity SC was previously monitoring the availability of switching system S_{1b}, and said system appears to be undisrupted, this can take place immediately.

The activation of the interfaces of switching system S_{1b} takes place by means of the control entity SC positively acknowledging the cyclical requests from switching system S_{1b}. As a result of this, the central controller CP of the switching system S_{1b} explicitly sets the interfaces IFₙ to the active switching state. In addition, future requests from switching system S₁ are negatively acknowledged or left unacknowledged by the control entity SC, whereby the central controller CP explicitly sets the interfaces IFₙ to the inactive switching state, which also takes place immediately after becoming operational following repair.

The IP failover addresses of switching system S₁ are now notified to the preceding routers. The same applies for external non-failover addresses if this has not yet taken place. The external signaling which arrives via the routers is handled by the switching system S_{1b} from then on.

If the error originates from a communication fault between switching system S₁ and the control entity SC, switching system S₁ detects the non-availability of the control entity SC and assumes that the control entity SC will change over to switching system S_{1b}. As a result, switching system S₁ automatically deactivates its interfaces due to the loss of communication with control entity SC. This ensures that only one of the two switching systems S₁ and S_{1b} is active at any time.

Following the repair or re-availability of the communication between the control entity SC and switching system S₁, it is possible to revert to switching system S₁ again. This is not absolutely essential, but can be supported as an option.

In order to prevent a loss of communication between the control entity SC and both switching system S₁ and switching system S_{1b} from causing a total failure of both switching systems S₁ and S_{1b}, the network management NM is continuously informed by the control entity SC and the switching systems of a substitutive connection and the forthcoming disconnection of a switching system, and can halt this if necessary. It is also possible optionally to offer a confirmation mode for the operator at the network management NM.

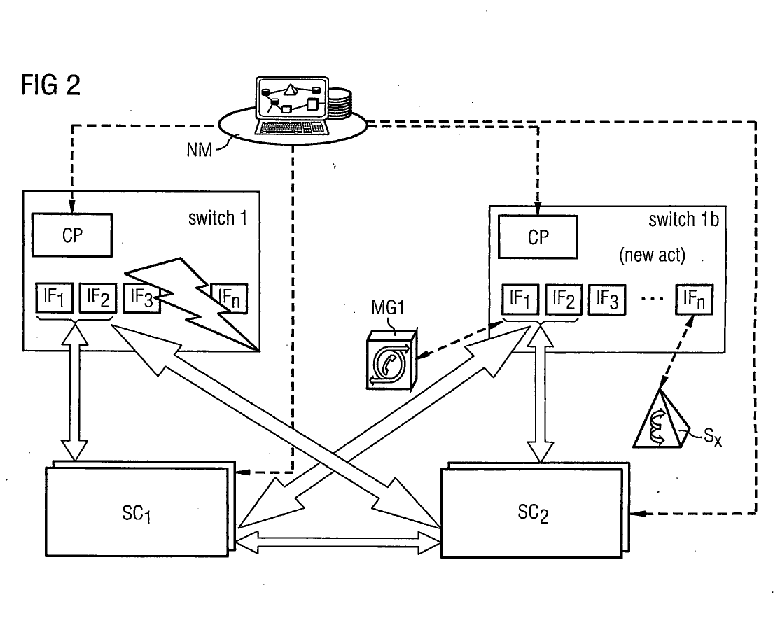

Let us assume that the same failure scenario in respect of the switching systems now occurs on a configuration which is shown in FIG. 2. The difference compared with the configuration shown in FIG. 1 is in the provision of two control entities SC₁ and SC₂ which are arranged at different locations. The control entity SC therefore consists of the two halves SC₁ and SC₂.

In accordance with FIG. 2, the two (spatially separate) control entities SC₁ and SC₂ monitor each other reciprocally. If the communication fails between the two control entities SC₁ and SC₂, no further automatic substitutive connection instructions are sent by a control entity. During the isolation of the two control entities SC₁ and SC₂, the operating state of the switching systems which was most recently determined in the two control entities SC₁ and SC₂ is maintained. This is possible because the two control entities SC₁ and SC₂ are still separately active. This prevents the two control entities SC₁ and SC₂ from independently effecting inconsistent settings of the switching systems S₁ and S_{1b}. The central parts CP of the switching systems S and S_{1b} are in contact with both control entities SC₁ and SC₂ and receive explicit instructions from control entities SC₁ and SC₂ for activating or deactivating their interfaces. These instructions are consistent because the two control entities SC₁ and SC₂ synchronized themselves previously in relation to this.

If switching system S₁ now fails, this will be detected by control entity SC₁ and SC₂. Both synchronize themselves and activate switching system S_{1b}. If switching system S₁ subsequently becomes operational again, this is again detected by control entity SC₁ and SC₂ and, following internal synchronization, switching system S₁ goes into the standby state as instructed by the control entity SC₁ and SC₂.

If solely the communication between control entity SC₁ and switching system S₁ was disrupted, this would likewise be detected by the two control entities SC₁ and SC₂ and substitutive connection would not take place.

If the communication between switching system S₁ and both control entities SC₁ and SC₂ is disrupted, both control entities would activate switching system S_{1b}. According to the invention, switching system S₁ would deactivate itself as a result of the loss of communication with both control entities SC₁ and SC₂.

If control entity SC₁ fails, this is shown as a communication fault between both control entities SC₁ and SC₂. As a result of this, control entity SC₂ does not initiate any further substitutive connections, since there would then be a risk that control entity SC₁ also sets switching system S₁ and switching system S_{1b} in a manner which is not consistent with the settings of control entity SC₂. Since contact with SC₂ continues to exist, switching system 1b does not disconnect itself.

This configuration has the advantage of increased reliability, particularly in the case of automatic disconnection of an isolated switching system.

1-10. (canceled)

11. A method for substitute switching of spatially separated switching systems, comprising:
providing a pair of switching systems having one-to-one redundancy, comprising a first switching system in an active operating state in terms of switching, and a second switching system in a hot-standby operating state in terms of switching, the second switching system geographically separated from the first switching system;
establishing communication between a monitoring system and at least one of the paired switching systems; and
changing over in terms of switching from the active switching system to the hot-standby switching system in the event of a loss of communication to the switching system in the active operating state,
wherein the change over occurs in real time.

12. The method as claimed in claim 11,
wherein each switching system comprising a central controller,
the method further comprising exchanging test messages between the monitoring system and the central controllers of the paired switching systems.

13. The method as claimed in claim 12, wherein the messages are exchanged periodically.

14. The method as claimed in claim 12, wherein the exchange of the test messages between the monitoring system and the switching system in the active operating state is controlled via the switching system by sending a test request to the monitoring system and receiving a positive acknowledgement.

15. The method as claimed in claim 12, wherein the exchange of the test message between the monitoring system and the switching system in the hot-standby operating state is controlled via the switching system by sending a test request to the monitoring system and receiving a negative acknowledgement.

16. The method as claimed in claim 12, wherein the exchange of the test messages between the monitoring system and the switching system in the hot-standby operating state is controlled via the switching system by sending a test request to the monitoring system and receiving no acknowledgement.

17. The method as claimed in 12, further comprising:
reporting to the network management system by the monitoring system the loss of communication with the switching system in the active operating state; and
sending changeover instructions to the monitoring system.

18. The method as claimed in 12,
wherein the change over is controlled by the monitoring system by sending a positive acknowledgement to a test request sent by the switching system in hot-standby operating state, and
wherein the switching system in the hot-standby operating state is changed to the active operating state by the central controller after receiving the positive acknowledgement.

19. The method as claimed in 18, wherein the switching system with the communication loss is changed to the hot-standby operating state and is not automatically switched back to the active operating state following a resolution of the communication loss.

20. The method as claimed in 11, further comprising:
reporting to the network management system by the monitoring system the loss of communication with the switching system in the active operating state; and
sending changeover instructions to the monitoring system.

21. The method as claimed in 11,
wherein the change over is controlled by the monitoring system by sending a positive acknowledgement to a test request, and
wherein the switching system in the hot-standby operating state is changed to the active operating state after receiving the positive acknowledgement.

22. The method as claimed in 21, wherein the switching system with the communication loss is changed to the hot-standby operating state and is not automatically switched back to the active operating state following a resolution of the communication loss.

23. A monitoring system for monitoring a failure of an active switching system, comprising:
a first monitor comprising:
a first communication link to the active switching system, the active switching system in an active operating state in terms of switching,
a second communication link to a second switching system that is geographically separated from the first switching system, the second switching system in a hot-standby operating state in terms of switching;
a second monitor that is geographically separated from the first monitor, the second monitor comprising:
a first communication link to the active switching system, the active switching system in an active operating state in terms of switching,
a second communication link to a second switching system that is geographically separated from the first switching system, the second switching system in a hot-standby operating state in terms of switching; and
a communication link between the first and second monitors,
wherein a failure on the first communication link triggers the second switching system to change over to the active operating state, and
wherein the change over is in real time.

24. The monitoring system as claimed in claim 23, wherein the a communication loss between the first monitor and the active switching system causes a synchronization between the monitoring systems in order to trigger the second switching system to change over to the active operating state.

25. The monitoring system as claimed in claim 24, wherein the active switching system determined by both the first and second monitors is maintained active if a communication fault between the first and second monitors occurs.
